(19) United States
(12) Patent Application Publication
(10) Pub. No.: US 2011/0012887 A1
(43) Pub. Date: Jan. 20, 2011

(54) DISPLAY APPARATUS

(75) Inventors: Jae-Hoon LEE, Seoul (KR); Yong-Soon LEE, Cheonan-si (KR); Hoi-Sik MOON, Cheonan-si (KR); Chang-Soo LEE, Uijeongbu-si (KR)

Correspondence Address: CANTOR COLBURN LLP, 20 Church Street, 22nd Floor, Hartford, CT, 06103, US

(73) Assignee: SAMSUNG ELECTRONICS CO., LTD, Suwon-si (KR)

(21) Appl. No.: 12/722,221

(22) Filed: Mar. 11, 2010

(30) Foreign Application Priority Data
Jul. 15, 2009 (KR) 2009-0064306

(51) Int. Cl. G09G 5/00

(52) U.S. Cl. 345/212

(57) ABSTRACT

A display apparatus includes a display panel and a data driving part. The display panel includes pixels, data lines and gate lines. A transverse side of the pixels is disposed adjacent to the data lines extending along a first direction, and a longitudinal side of the pixels is disposed adjacent to the gate lines extending along a second direction. Two adjacent pixels of the pixels disposed adjacent to each other along the second direction are connected to one gate line of the gate lines. The data driving part transmits two-dot-inversed first direction data voltages to pixels disposed along the second direction and two-dot-inversed second direction data voltages to pixels disposed along the first direction.

This application claims priority to Korean Patent Application No. 2009-64306, filed on Jul. 15, 2009, and all the benefits accruing therefrom under 35 U.S.C. §119, the content of which in its entirety is herein incorporated by reference.

### BACKGROUND OF THE INVENTION

(1) Field of the Invention

The present invention relates to a display apparatus. More particularly, the present invention relates to a display apparatus having substantially improved display quality.

(2) Description of the Related Art

A liquid crystal display (“LCD”) apparatus typically includes an LCD panel and a backlight unit which provides a light to the LCD panel. The LCD panel may include data lines and gate lines crossing the data lines. The data lines and the gate lines may define pixels.

Recently, a pixel structure having a reduced number of required data driving circuits has been developed to reduce manufacturing cost of the LCD apparatus. For example, a left pixel and a right pixel may share one data line in the pixel structure. As a result, a required number of the data lines may be reduced by half, and the required number of the data driving circuits may also be reduced by half.

In another pixel structure, the data lines extend along a long side direction of a display panel and the gate lines extend along a short side direction, substantially perpendicular to the long side direction, of the display panel. When the data lines extend along the long side direction of the display panel, the data lines are alternately arranged along the short side direction of the display panel. Accordingly, the number of data lines may be less than for a structure in which the data lines are alternately arranged along the long side direction, and the number of data driving circuits may be thereby substantially reduced.

The pixel structure including the reduced number of data lines may generate kickback voltage variation, however, due to a charging timing between pixels in accordance with an inversion driving of the LCD apparatus. When the kickback voltage variation is generated, the LCD apparatus has display defects such as stripe defects and flicker in a certain pattern, for example.

### BRIEF SUMMARY OF THE INVENTION

An exemplary embodiment of a display apparatus according to the present invention includes a reduced number of data lines to improve display quality.

In an exemplary embodiment, a display apparatus includes a display panel and a data driving part. The display panel includes pixels, data lines extending along a first direction and a plurality of gate lines extending along a second direction substantially perpendicular to the first direction. Each of the pixel includes a transverse side disposed adjacent to at least one gate line of the data lines, and a longitudinal side disposed adjacent to at least one of the gate lines. Two adjacent pixels, which are aligned adjacent to each other along the first direction, are electrically connected to a same gate line of the gate lines disposed between the two adjacent pixels. The data driving part transmits two-dot-inversed first direction data voltages to pixels disposed along the first direction and two-dot-inversed second direction data voltages to pixels disposed along the second direction.

In another exemplary embodiment, a display apparatus includes a display panel and a data driving part. The display panel includes a first data line extending along a first direction, a second data line extending along the first direction, a third data line extending along the first direction, a fourth data line extending along the first direction, a first pixel, a second pixel, a third pixel, a fourth pixel, a first gate line extending along a second direction, substantially perpendicular to the first direction, and disposed between the first and second pixels and between the third and fourth pixels, a second gate line extending along the second direction, a first contact portion disposed adjacent to the second data line, a second contact portion disposed adjacent to the first data line, a third contact portion disposed adjacent to the fourth data line and a fourth contact portion disposed adjacent to the third data line. The first pixel is disposed between the first data line and the second data line and connected to the second data line through the first contact portion, the second pixel is disposed between the first data line and the second data line and connected to the first data line through the second contact portion, the third pixel is disposed between the third data line and the fourth data line and connected to the fourth line through the third contact portion and the fourth pixel is disposed between the third data line and the fourth data line and connected to the third data line through the fourth contact portion. The data driving part transmits one-dot-inversed first direction data voltages to pixels disposed along the first direction and two-dot-inversed second direction data voltages to pixels disposed along the second direction.

In an exemplary embodiment, contact portions which connects transistors and pixel electrodes are substantially uniformly disposed throughout a display panel, and the display panel is driven along a longitudinal side direction using at least one of one-dot inversion method and two-dot inversion method and is driven along a transverse side direction using two-dot inversion method, and display quality of the display apparatus is thereby substantially improved.

### BRIEF DESCRIPTION OF THE DRAWINGS

The above and other features and aspects of the present invention will become more readily apparent by describing in further detail exemplary embodiments thereof with reference to the accompanying drawings, in which:

FIG. 1 is a block diagram illustrating an exemplary embodiment of a display apparatus according to the present invention;

FIG. 2 is a plan view illustrating an exemplary embodiment of an arrangement structure of the data lines, the gate lines and the pixels of the display panel using an inversion driving method;

FIG. 3 is a plan view illustrating a data fan-out part for the inversion driving of FIG. 2;

FIG. 4 is a plan view illustrating a display panel according to an exemplary applying the data fan-out part of FIG. 3;

FIG. 5 is a block diagram illustrating a data driving part for an inversion driving of FIG. 2;

FIG. 6 is a plan view illustrating another exemplary embodiment of an arrangement structure of the data lines, the gate lines and the pixels of the display panel using an inversion driving method;

FIG. 7 is a plan view illustrating an exemplary embodiment of an arrangement structure of the data lines, the gate lines and the pixels of the display panel using an inversion driving method;

FIG. 8 is a plan view illustrating another exemplary embodiment of an arrangement structure of the data lines, the gate lines and the pixels of the display panel using an inversion driving method;

FIG. 9 is a plan view illustrating an exemplary embodiment of an arrangement structure of the data lines, the gate lines and the pixels of the display panel using an inversion driving method;

FIGS. 10A and 10B are plan views illustrating an exemplary embodiment of a stripe according to the present invention;

FIG. 11A is a plan view illustrating an exemplary embodiment of a display apparatus according to the present invention;

FIG. 11B is a signal timing diagram illustrating an exemplary embodiment of a coupling of a common voltage according to the present invention;

FIG. 12 is a plan view illustrating a gate metal pattern and source metal pattern; and

FIG. 13A is a plan view illustrating a display apparatus using two-dot inversion in the longitudinal side direction and including gate lines misaligned toward a left side of the display apparatus plan view illustrating a display apparatus using two-dot inversion in the longitudinal side direction and including gate lines misaligned toward a left side of the display apparatus; and

FIG. 13B is a signal timing diagram showing an exemplary embodiment of waveforms of voltages applied to the pixels in FIG. 13A.

### DETAILED DESCRIPTION OF THE INVENTION

The present invention is described more fully hereinafter with reference to the accompanying drawings, in which various embodiments are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

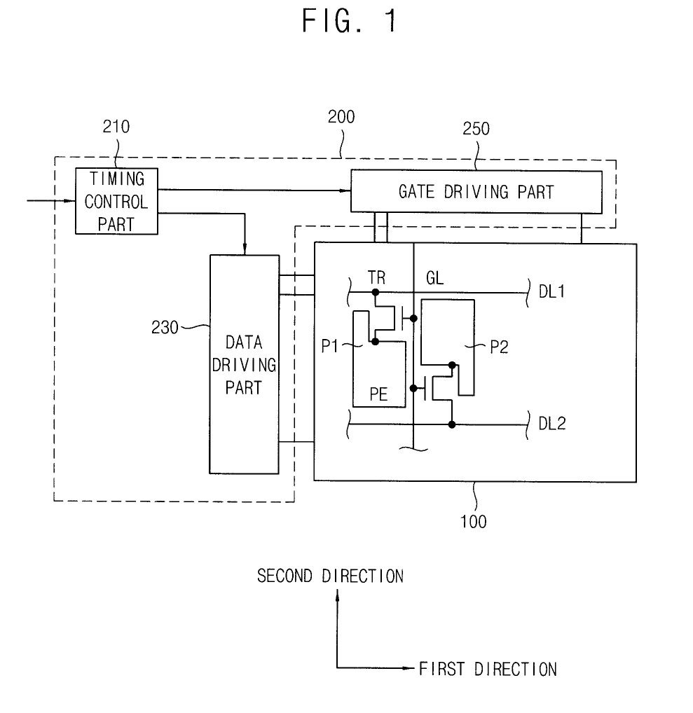

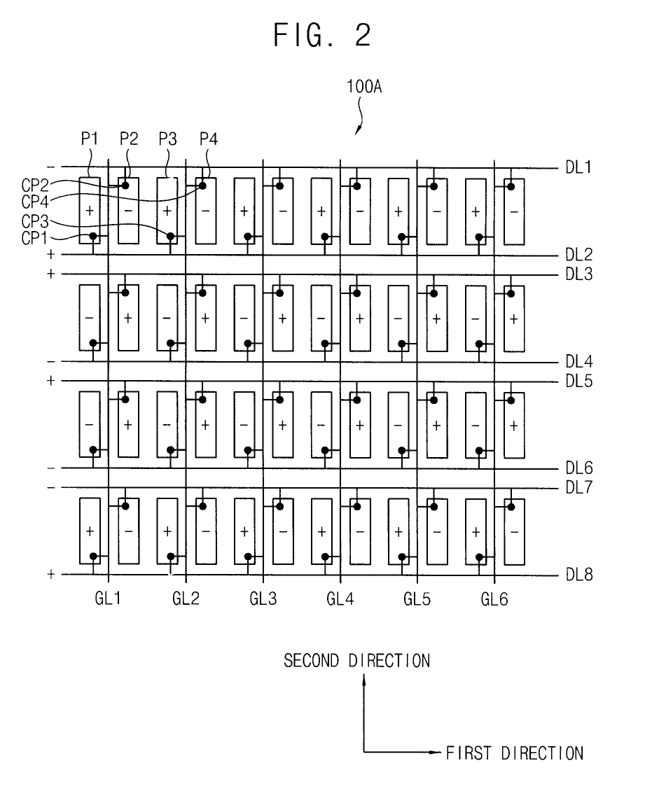

FIG. 1 is a block diagram illustrating an exemplary embodiment of a display apparatus according to the present invention. FIG. 2 is a schematic diagram illustrating an exemplary embodiment of an arrangement structure of the data lines, the gate lines and the pixels of the display panel using an inversion driving method.

As shown in FIG. 1, the display apparatus includes a display panel 100 and a panel driving section 200.

A shape of a frame of the display panel 100 may include a longitudinal side which extends along a first direction and a transverse side which extends along a second direction crossing the first direction, e.g., which is substantially perpendicular to the first direction, as shown in FIG. 1. The display panel 100 includes pixels P (e.g., two adjacent pixel P1 and P2 as shown in FIG. 1; additional embodiments are not limited thereto) disposed in a matrix pattern, e.g., having rows and columns, gate lines GL and data lines DL, e.g., two adjacent data lines DL1 and DL2, as shown in FIG. 1. The gate lines GL extend along the second direction, which is a direction substantially parallel to a plane defined by the transverse side of the display panel 100, and are disposed along the first direction, which is a direction substantially parallel to a plane defined by the longitudinal side of the display panel 100, as shown in FIG. 1. The data lines DL, e.g., the two adjacent data lines DL1 and DL2, extend along the first direction, e.g., along the longitudinal side of the display panel 100, and are alternately disposed along the second direction, e.g., along the transverse side of the display panel 100. One of the gate lines GL defines a longitudinal side of each of the two adjacent pixels P1 and P2, and the two adjacent data lines DL1 and DL2 define transverse sides of the each of the two adjacent pixels P1 and P2.

A first pixel P1 of the two adjacent pixels P1 and P2 includes a transistor TR connected to a first data line DL1 of the two adjacent data lines DL1 and DL2 and the one of the gate lines GL, a pixel electrode PE connected to the transistor TR and a color filter (not shown). In an exemplary embodiment, first column pixels including the first pixel P1 may include a red filter, and second column pixels column including the second pixel P2 may include a green filter. Third column pixels including the third pixel P3 may include a blue filter. The red, green and blue filters may be alternately disposed along the first direction of the display panel 100.

The panel driving section 200 includes a timing control part 210, a data driving part 230 and a gate driving part 250. The timing control part 210 receives data signals and a synchronization signal from an external source (not shown), and generates driving control signals which drive the display panel 100 using the synchronization signal. The driving control signals include gate control signals which controls the gate driving part 250.

The data driving part 230 converts digital data signals received from at least one of the timing control part 210 and the external source into analog data voltages. The data driving part 230 determines polarities of the data voltages in accordance with an inversion method to output the data voltages to the data lines DL1 and DL2. In an exemplary embodiment, the data driving part 230 may be disposed adjacent to the transverse side of the display panel 100 and ends of the data lines DL1 and DL2. The gate driving part 250 generates the gate signals using gate on/off voltages received from the external source, based on the gate control signal to transmit the gate signals to the gate lines GL. In an exemplary embodiment, the gate driving part 250 may be disposed adjacent to the longitudinal side of the display panel 100 and ends of the gate lines GL.

The panel driving section 200 drives the display panel 100 in accordance with an inversion method. In an exemplary embodiment, as shown in FIG. 2, the panel driving section 200 drives a display panel 100A (FIG. 2) according to one or more embodiments using 1×2 dot inversion method inversing by one dot in the first direction and by two dots in the transverse side direction. The polarities of voltages applied to two dots may be different from each other.

As shown in FIG. 2, the display panel 100A includes a plurality of pixels. The pixels are disposed in a matrix structure in which pixel rows are disposed in the first direction that is the longitudinal side direction of the display panel 100A, and pixel columns are disposed in the second direction that is the transverse side direction of the display panel 100A.

Each of the gate lines, e.g., a first gate line GL1, a second gate line GL2, a third gate line GL3, a fourth gate line GL4, a fifth gate line GL5 or a sixth gate line GL6, is connected to the pixels in two adjacent pixel columns. In an exemplary embodiment, a first pixel column and a second pixel column adjacent to the first pixel column are connected to the first gate line GL1. The data lines, e.g., a first data line DL1, a second data line DL2, a third data line DL3, a fourth data line DL4, a fifth data line DL5, a sixth data line DL6, a seventh data line DL7 and an eighth data line DL8, extend in the first direction that is the longitudinal side of the display panel 100A, and are disposed along the second direction that is the transverse side of the display panel 100A. Each of the data lines, e.g., the first data line DL1, the second data line DL2, the third data line DL3, the fourth data line DL4, the fifth data line DL5, the sixth data line DL6, the seventh data line DL7 or the eighth data line DL8 is connected to pixels in a pixel rows. The first data line DL1 receives a first data voltage having a first polarity, and the second data line DL2 receives a second data voltage having a second polarity. A phase of the second voltage is inverted from a phase of the first voltage with respect to a common voltage.

In an exemplary embodiment, the first data line DL1 and the second data line DL2 adjacent to the first data line are connected to pixels in a first pixel row disposed along the first direction. Each pixel of the plurality of pixels includes the transistor TR, the pixel electrode PE and a contact portion connected to the transistor TR and the pixel electrode PE.

The display panel 100A includes contact portions CP. The contact portions are substantially uniformly disposed on the display panel 100A.

In an exemplary embodiment, a first pixel P1 disposed in the first pixel row and a second pixel P2 disposed in the first pixel row adjacent to the first pixel P1 are connected to the first gate line GL1, and the first pixel P1 and the second pixel P2 include a first contact portion CP1 and a second contact portion CP2, respectively. The first contact portion CP1 is disposed at a lower portion of the first pixel P1 adjacent to the second data line DL2. The second contact portion CP2 is disposed at an upper portion of the second pixel P2 adjacent to the first data lines DL1. Similarly, a third pixel P3 disposed in the first pixel row and a fourth pixel P4 disposed in the first pixel row adjacent to the third pixel P3 are connected to the second gate line GL2, and the third pixel P3 and the fourth pixel P4 include a third contact portion CP3 and a fourth contact portion CP4, respectively. The third contact portion CP3 is disposed at a lower portion of the third pixel P3 adjacent to the second data line DL2. The fourth contact portion CP4 is disposed at an upper portion of the fourth pixel P4 adjacent to the first data lines DL1. The contact portions of the pixels disposed in the first pixel row are disposed along the first direction to be alternately adjacent to the first data lines DL1 and the second data lines DL2.

A contact portion of a pixel disposed in the first pixel column, e.g., the first contact portion of the first pixel P1, is disposed at a position in the pixel substantially the same as a position at which first contact portion CP1 is disposed in the first pixel P1. In an exemplary embodiment, contact portions of the pixels disposed in the first pixel column are disposed adjacent to even-numbered data lines, e.g., the second data line DL2, the fourth data line DL4, the sixth data line DL6 and the eighth data line DL8, which are disposed below the pixel columns.

A contact portion of a pixel disposed in the second pixel column, e.g., the second contact portion of the second pixel P2, is disposed at a position in the pixel substantially the same as a position at which the second contact portion CP2 is disposed in the second pixel P2. In an exemplary embodiment, contact portions of the pixels disposed in the second pixel column are disposed adjacent to odd-numbered data lines, e.g., the first data line DL1, the third data line DL3, the fifth data line DL5 and the seventh data line DL7, which are disposed below the pixel rows.

A contact portion of a pixel disposed in a third pixel column, e.g., the third contact portion of the third pixel P3, is disposed at a position in pixel substantially the same as a position at which the third contact portion CP3 is disposed in the third pixel P3. In an exemplary embodiment, the contact portions of the pixels disposed in the third pixel column are disposed adjacent to even-numbered data lines, e.g., the second data line DL2, the fourth data line DL4, the sixth data line DL6 and the eighth data line DL8, which are disposed below the pixel rows.

In an exemplary embodiment, contact portions of the pixels that are disposed in the first pixel row and receive data voltages of positive polarity (“+”), e.g., the first contact portion CP1 and the third contact portion CP3, are disposed on lower portions of the pixels adjacent to the second data line DL2. Contact portions of the pixels that re disposed in the first pixel row and receive data voltages of negative polarities, e.g., the second contact portion CP2 and the fourth contact portion CP4, are disposed on upper portions of the pixels adjacent to the first data line DL1. In an exemplary embodiment, contact portions of pixels that are disposed in the second pixel row adjacent to the first pixel row and receive voltages of positive polarity are disposed on portions opposite to portions on which the contact portions of pixels that disposed in the first pixel row and receive voltages of positive polarity are disposed, and contact portions of pixels that are disposed in the second pixel row and receive voltages of negative polarity are disposed on portions opposite to portions on which the contact portions of pixels that are disposed in the first pixel row and receive voltages of negative polarity are disposed. The contact portions of pixels that are disposed in the second pixel row and receive data voltages of positive polarity are disposed on upper portions of the pixels adjacent to the third data line DL3 and the contact portions of pixels in the second pixel row that receive data voltages of negative polarity (“−”) are disposed on lower portions of the pixels adjacent to the fourth data line DL4.

In the embodiment shown in FIG. 2, contact portions of pixels in the first pixel row that receive data voltages of same polarity are disposed on a same portion of the pixels. In an exemplary embodiment, a contact portion of a pixel that are disposed in the first pixel row and receives a data voltage having a negative polarity is disposed on an upper portion of the pixel adjacent to the first data line DL1 disposed above the first pixel row, and a contact portion of a pixel that are disposed in the first pixel row and receives a data voltage having a positive polarity is disposed on a lower portion of the pixel adjacent to the second data line DL2 disposed below the first pixel row. Contact portions of the pixel that are disposed in the second pixel row and receive data voltages of same polarity are disposed on a same portion of the pixels. In an exemplary embodiment, a contact portion of a pixel that are disposed in the second pixel row and receives a data voltage having a negative polarity is disposed adjacent to the fourth data lines DL4 disposed below the second pixel row, and a contact portion of a pixel that are disposed in the second pixel row and receives a data voltage having a positive polarity is disposed adjacent to the third data lines DL3 disposed above the second pixel row. Accordingly, in the display panel 100A, contact portions of pixels that receive data voltages of same polarity voltage may be substantially uniformly disposed on the upper portion of the pixels or the lower portion of the pixels.

In an exemplary embodiment, the display panel 100A receives eight-inversed data voltages and thereby drives the display panel using 1×2 dot inversion method. An (8k−7)-th data line (‘k’ is a natural number), an (8k−6)-th data line, an (8k−5)-th data line, an (8k−4)-th data line, an (8k−3)-th data line, an (8k−2)-th data line, an (8k−1)-th data line and an 8k-th data line, for example, the first data line DL1 to the eighth data line DL8, receive eight data voltages having a polarity pattern of (−, +, +, −, +, −, −, +). The polarity pattern are repeated in every eight data voltages applied to the (8k−7)-th data line, the (8k−6)-th data line, the (8k−5)-th data line, the (8k−4)-th data line, the (8k−3)-th data line, the (8k−2)-th data line, the (8k−1)-th data line and the 8k-th data line. The even-numbered data lines, e.g., the second data line DL2, the fourth data line DL4, the sixth data line DL6 and the eighth data line DL8, receive a data voltage having a positive polarity, a data voltage having a negative polarity, a data voltage having a negative polarity and a data voltage having a positive polarity, respectively, and the odd-numbered data lines, e.g., the first data line DL1, the third data line DL3, the fifth data line DL5 and the seventh data line DL7 receive a data voltage having a negative polarity, a data voltage having a positive polarity, a data voltage having a positive polarity and a data voltage having a negative polarity, respectively. As described above, the polarities of the first data line DL1 to the fourth data line DL4 may be opposite to the polarities of the fifth data line DL5 to the nine data line DL9, respectively.

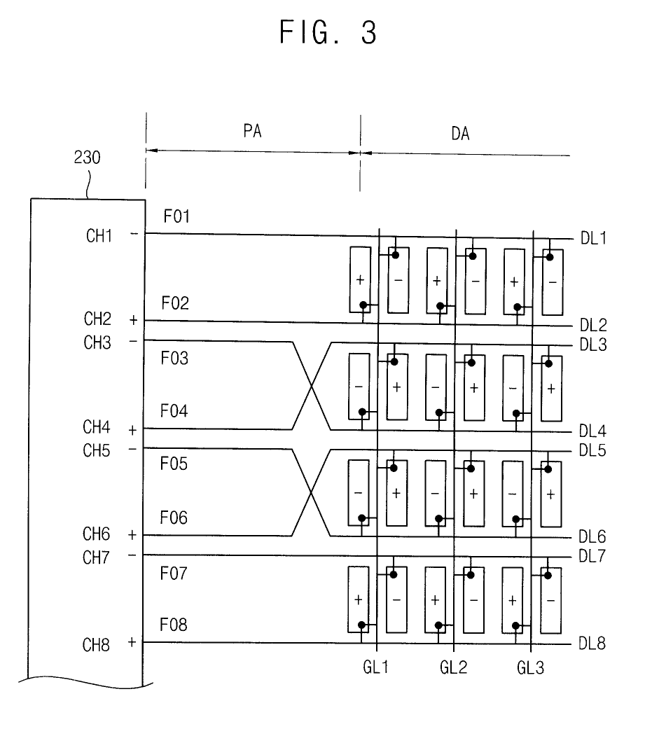

FIG. 3 is a plan view illustrating an exemplary embodiment of a data fan-out part for the inversion driving of FIG. 2.

Referring back to FIG. 1 and as shown in FIG. 3, the data driving part 230 includes output channels, e.g., a first output channel CH1, a second output channel CH2, a third output channel CH3, a fourth output channel CH4, a fifth output channel CH5, a sixth output channel CH6, a seventh output channel CH7 and an eighth output channel CH8, and each of the output channels CH1, CH2, CH3, CH4, CH5, CH6, CH7 and CH8 is connected to one of the data lines, e.g., the first data line DL1, the second data line DL2, the third data line DL3, the fourth data line DL4, the fifth data line DL5, the sixth data line DL6, the seventh data line DL7 and the eighth data line DL8.

The display panel 100A includes data fan-out parts which connect the data lines DL1, DL2, DL3, DL4, DL5, DL6, DL7 and DL8 to the output channels CH1, CH2, CH3, CH4, CH5, CH6, CH7 and CH8. The data lines DL1, DL2, DL3, DL4, DL5, DL6, DL7 and DL8 may be disposed in a display area DA of the display panel 100A. The data fan-out parts may be disposed in a portion of the peripheral area PA surrounding at least a portion of the display area DA.

The data fan-out parts include a first data fan-out part F01 which connects the first output channel CH1 to the first data line DL1, a second data fan-out part F02 which connects the second output channel CH2 to the second data line DL2, a third data fan-out part F03 which connects the third output channel CH3 to the fourth data line DL4, and a fourth data fan-out part F04 which connects the fourth output channel CH4 to the third data lines DL3.

The data fan-out parts further include a fifth data fan-out part F05 which connects the fifth output channel CH5 to the sixth data line DL6, a sixth data fan-out part F06 which connects the sixth output channel CH6 to the fifth data line DL5, a seventh data fan-out part F07 which connects the seventh output channel CH7 to the seventh data line DL7, and an eighth data fan-out part F08 which connects the eighth output channel CH8 to the eighth data line DL8.

The data driving part 230 outputs data voltages having polarities alternately different from one another in accordance with two-inversion method. In an exemplary embodiment, odd-numbered output channels, e.g., the first output channel CH1, the third output channel CH3, the fifth output channel CH5 and the seventh output channel CH7, of the data driving part 230 output data voltages having negative polarity, and even-numbered output channels, e.g., the second output channel CH2, the fourth output channel CH4, the sixth output channel CH6 and the eighth output channel CH8, of the data driving part 230 output data voltages having positive polarity. The data driving part 230 may output data voltages by inverting the polarities of the data voltages every frame.

In an exemplary embodiment, the data fan-out parts cross one another to transmit the data voltage to the display panel 100A in the eight-inversion method using the data driving part 230 of the two inversion method.

As shown in FIG. 3, the third data fan-out part F03 and the fourth data fan-out part F04 may cross each other to be connected to the fourth data line D4 and the third data line, respectively, and thereby transmit a data voltage having a negative polarity to the first data line DL1, a data voltage having a positive polarity to the second data line DL2, a data voltage having a positive polarity to the third data line DL3 and a data voltage having a negative polarity to the fourth data line DL4. The fifth data fan-out part F05 and the sixth data fan-out part F06 may cross each other to be connected to the sixth data line D6 and the fifth data line D5, respectively, and thereby transmit a data voltage having a positive polarity to the fifth data line DL5, a data voltage having a negative polarity to the sixth data line DL6, a data voltage having a negative polarity to the seventh data line DL7 and a data voltage having a positive polarity to the eighth data line DL8.

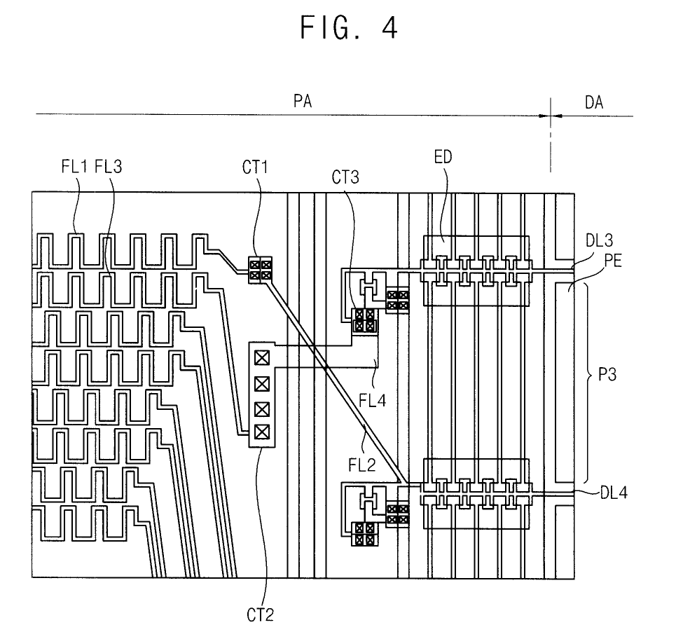

FIG. 4 is a plan view illustrating an exemplary embodiment of a display panel including the data fan-out part of FIG. 3.

Referring back to FIG. 3 and as shown in FIG. 4, the third data fan-out part F03 and the fourth data fan-out part F04 which cross each other are disposed on the peripheral area PA of the display panel 100A. The third fan-out part F03 includes a first fan line FL1 and a second fan line FL2, and the fourth fan-out part F04 includes a third fan line FL3 and a fourth fan line FL4.

The first fan line FL1 includes a first conductive pattern and extends from a pad connected to the third output channel CH3 of the data driving part 230. The second fan line FL2 includes a second conductive pattern and connected to the first fan line FL1 through a first contact hole CT1. The second fan line FL2 is connected to the fourth data line DL4. The fourth data line DL4 includes the second conductive pattern. In an exemplary embodiment, the second fan line FL2 may be connected to the fourth data line DL4 through one of static electric diode parts ED. The static electric diode parts ED effectively protect the pixels disposed on the display area DA from static electricity.

The third fan lines FL3 includes in the first conductive pattern and extends from a pad connected to the fourth output channel CH4 of the data driving part 230. The fourth fan line FL4 includes a third conductive pattern and connected to the third fan line FL3 through a second contact hole CT2. The fourth fan line FL4 is connected to the third data lines DL3 disposed in the second conductive pattern through a third contact hole CT3. In an exemplary embodiment, the fourth fan line FL4 may be connected to the third data line DL3 through one of the static electric diode parts ED. The first conductive pattern may include a same material as a material included in the gate lines, the second conductive pattern may include a same material as a material included in the data lines, and the third conductive pattern may include a same material as a material included in the pixel electrode.

In FIGS. 3 and 4, a method including the data fan-out parts which cross each other is shown as an exemplary embodiment of driving using the 4-inversion method of the display panel 100A and the one-inversion method of the data driving part 230. In another exemplary embodiment, the display panel 100A may be driven using the 4-inversion method with various methods including a method of crossing the data fan-out parts and the two-inversion method of a data driving part.

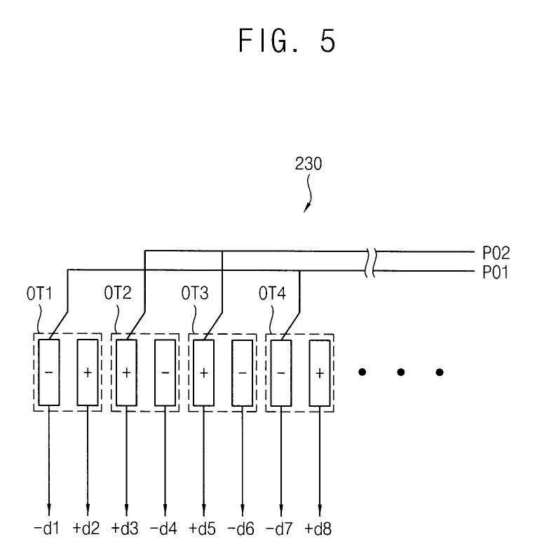

FIG. 5 is a block diagram illustrating an exemplary embodiment of a data driving part in FIG. 1.

Referring to FIG. 1 and as shown in FIG. 5, the data driving part 230 includes output parts, e.g., a first output part OT1, a second output part OT2, a third output part OT3, a fourth output part OT4. Each of the output parts is connected to two adjacent output channels which output an odd-numbered data voltage and an even-numbered data voltage, respectively. The output parts OT1, OT2, OT3 and OT4 determine polarities of data voltages based on an inversion signal received from the timing control part 210 and thereby output the data voltages. When the inversion signal applied to the each of the output parts have a value of “1,” the each of the output parts outputs an odd-numbered data voltage of positive polarity and an even-numbered data voltage of negative polarity through the two adjacent output channels. When the inversion signal has a value of “0,” the each of the output parts outputs an odd-numbered data voltage of negative polarity and an even-numbered data voltage of positive polarity through the two adjacent output channels.

In an exemplary embodiment, the timing control part 210 transmits a first inversion signal P01 and a second inversion signal P02 to the data driving part 230 in accordance with the four-inversion method.

The first inversion signal P01 may be transmitted to the first output part OT1 and the fourth output part OT4, and the second inversion signal P02 may be transmitted to the second output part OT2 and the third output part OT3. As shown in FIG. 5, the data driving part 230 receives the first inversion signal P01 having value of “0” and the second inversion signal P02 having value of “1”. The first output part OT1 outputs a first data voltage −d1 of negative polarity and a second data voltage +d2 of positive polarity. The second output part OT2 outputs a third data voltage +d3 of positive polarity and a fourth data voltage −d4 of negative polarity. The third output part OT3 outputs a fifth data voltage +d5 of positive polarity and a sixth data voltage −d6 of negative polarity. The fourth output part OT4 outputs a seventh data voltage −d7 of negative polarity and a eighth data voltage +d8 of positive polarity.

Accordingly, the data driving part 230 outputs data voltages of polarities corresponding to the four-inversion method.

The same or like elements shown in drawings described hereinafter have been labeled with the same reference characters as used above to describe the exemplary embodiments of display panel shown in FIG. 2, and any repetitive detailed description thereof will be omitted or simplified.

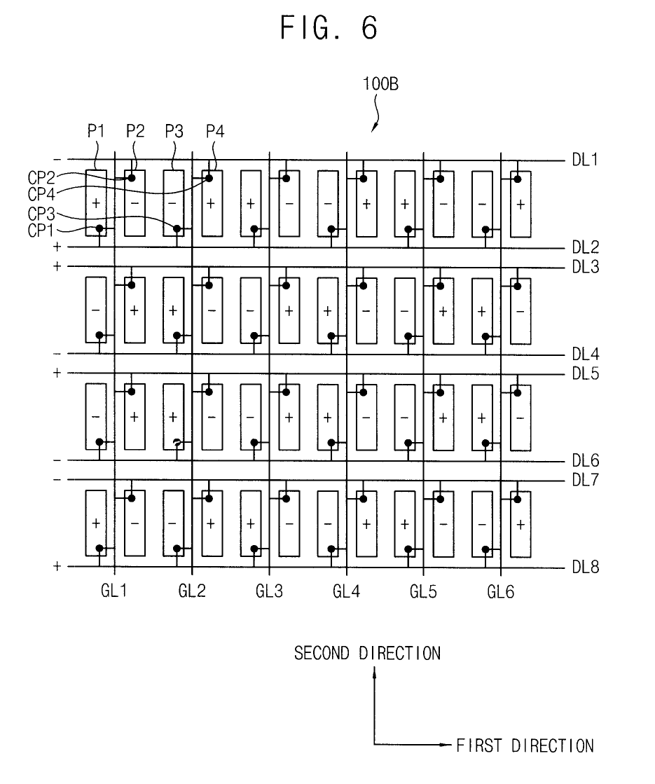

FIG. 6 is a plan view illustrating an exemplary embodiment of an arrangement structure of the data lines, the gate lines and the pixels of the display panel using an inversion driving method.

Referring to FIG. 1, and as shown in FIG. 6, an embodiment shown in FIG. 6 is substantially the same as an embodiment shown in FIG. 2 except that the display panel 100B of FIG. 6 is driven using two-dot-inversion in a first direction which is the direction of the longitudinal side and two-dot-inversion in a second direction which is the direction of the transverse side, and the display panel 100B is thereby driven using a 2×2 dot-inversion method. The two dots may receive data voltages of different polarities.

The (8k−7)-th data line (‘k’ is a natural number), the (8k−6)-th data line, the (8k−5)-th data line, the (8k−4)-th data line, the (8k−3)-th data line, the (8k−2)-th data line, the (8k−1)-th data line and the 8k-th data line of the display panel 100B, for example, a first data line DL1 to the eighth data line DL8, receive data voltages in accordance with a four-inversion method, e.g., data voltages having polarities inversed by one horizontal interval. In an exemplary embodiment, during a first horizontal interval H1, the first data line DL1, the second data line DL2, the third data line DL3, the fourth data line DL4, the fifth data line DL5, the sixth data line DL6, the seventh data line DL7 and the eighth data line DL8 receive data voltages having a polarity pattern of (−, +, +, −, +, −, −, +) during a second horizontal interval H2, the first data line DL1, the second data line DL2, the third data line DL3, the fourth data line DL4, the fifth data line DL5, the sixth data line DL6, the seventh data line DL7 and the eighth data lines DL8 respectively receive the data voltages having a polarity pattern of (+, −, −, +, −, +, +, −), and during a third horizontal interval H3, the first data line DL1, the second data line DL2, the third data line DL3, the fourth data line DL4, the fifth data line DL5, the sixth data line DL6, the seventh data line DL7 and the eighth data line DL8 receive data voltages having a polarity pattern of (−, +, +, −, +, −, −, +). A driving method using the data voltages having polarities inversed by the one horizontal interval H will be referred to as a column inversion method hereinafter.

The display panel 100B includes pixels including contact portions, and the contact portions are substantially uniformly disposed on the display panel 100B. Contact portions of the pixels in a same pixel column that receive data voltages having a same polarity are alternately disposed to be adjacent to data lines disposed above and below the pixels.

In an exemplary embodiment, the contact portions of the pixels in the first pixel row that receive the data voltages of positive polarity, e.g., the first contact portion CP1 and the fourth contact portion, are alternately disposed on the lower portion and the upper portion of the pixels, which are adjacent to the second data line DL2 and the first data line DL1, respectively. The contact portions of the pixels in the first pixel row that receive the data voltage of negative polarity, e.g., the second contact portion CP2 and the third contact portion CP3, are disposed on the upper portion and the lower portion of the pixels, which are adjacent to the first data line DL1 and the second data line DL2, respectively. In an exemplary embodiment, contact portions of pixels that are disposed in the second pixel row adjacent to the first pixel row and receive voltages of positive polarity are disposed on portions opposite to portions on which the contact portions of pixels that disposed in the first pixel row and receive voltages of positive polarity are disposed, and contact portions of pixels that are disposed in the second pixel row and receive voltages of negative polarity are disposed on portions opposite to portions on which the contact portions of pixels that are disposed in the first pixel row and receive voltages of negative polarity are disposed.

The data driving part 230 driving the display panel 100B determines polarities of the data voltages according to a one-dot inversion method and a column inversion method. In an exemplary embodiment, the display panel 100B may include the data fan-out parts which cross each other and the data driving part driving which may drive the display panel using the one-dot inversion and the column inversion. In an exemplary embodiment, the display panel 100B may be driven by the data driving part which drives in accordance with the four-inversion and the column inversion using the first inversion signal P01 and the second inversion signal P02, as shown in FIG. 5.

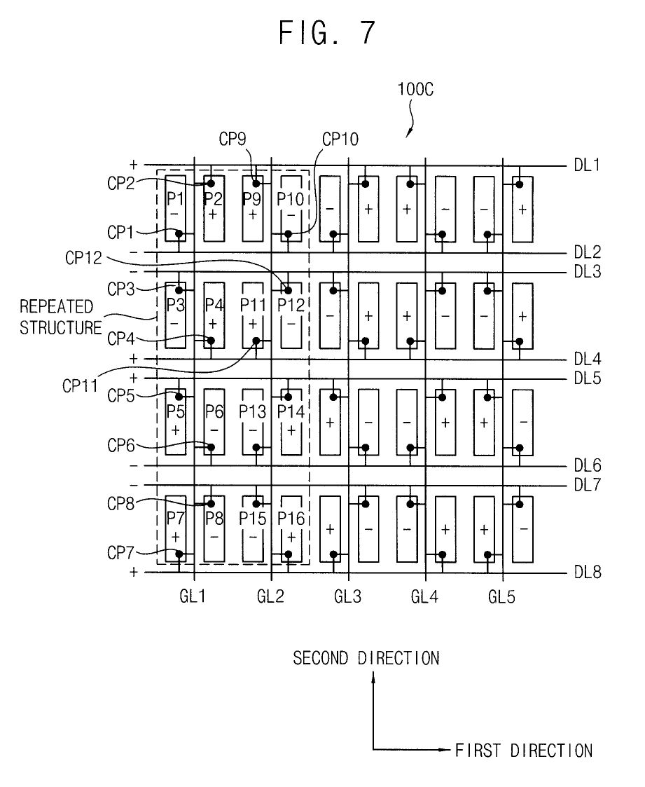

FIG. 7 is a plan view illustrating an exemplary embodiment of an arrangement structure of the data lines, the gate lines and the pixels of a display panel using an inversion driving method.

Referring to FIG. 1 and as shown in FIG. 7, the display panel 100C includes data lines, e.g., the first data line DL1 to the eighth data line DL8, gate lines, e.g., the first gate line GL1 to the fifth gate line GL5, and pixels connected to the data lines and the gate lines. The arrangement structure of the data lines DL1 to DL8, the gate lines GL1 to GL5 and the pixels is substantially the same with the arrangement structure of the embodiment described in FIG. 2 except for the inversion driving method, a connection structure between the pixels and the data lines and an arrangement structure of the contact portions.

The display panel 100C is driven using a 2×2 dot-inversion method, e.g., two-dot-inversed in a longitudinal side direction and two-dot-inversed in a transverse side direction. The two dots may receive voltages of different polarities. The display panel 100C receives the data voltages using a two-inversion method. In an exemplary embodiment, a (4k−3)-th data line (‘k’ is a natural number), a (4k−2)-th data line, a (4k−1)-th data line and a 4k-th data line, e.g., the first data line DL1, the second data line DL2, the third data line DL3 and the fourth data line DL4, receive data voltages having a polarity pattern of (+, −, −, +). The (4k−3)-th data line, the (4k−2)-th data line, the (4k−1)-th data line and the 4k-th data line may receive the data voltage having inversed polarities by a frame.

The connection structure between the pixel and data line and the arrangement structure of the contact portions of display panel 100C will be described hereinafter.

In an exemplary embodiment, the display panel 100C includes pixels, e.g., a first pixel P1, a third pixel P3, a fifth pixel P5 and a seventh pixel P7, which are disposed in a first pixel column and connected to a first gate line GL1, a second pixel P2, a fourth pixel P4, a sixth pixel P6 and an eighth pixel P8, which are disposed in a second pixel column connected to the first gate line GL1, a ninth pixel P9, an eleventh pixel P11, a thirteenth pixel P13 and a fifteenth pixel P15, which are disposed in a third pixel column and connected to a second gate line GL2 adjacent to the first gate line GL1, and a tenth pixel P10, a twelfth pixel P12, a fourteenth pixel P14 and a sixteenth pixel P16, which are disposed in a fourth pixel column connected to the second gate line GL2.

The first pixel P1 is connected to a second data line DL2 through a first contact portion CP1 disposed adjacent to the second line DL2, and the second pixel P2 is connected to a first data line DL1 through a second contact portion CP2 disposed adjacent to the first data line DL1. The third pixel P3 is connected to a third data line DL3 through a third contact portion CP3 disposed adjacent to the third data line DL3, and the fourth pixel P4 is connected to a fourth data line DL4 through a fourth contact portion CP4 disposed adjacent to the fourth data line DL4. The fifth pixel P5 is connected to a fifth data line DL5 through a fifth contact portion CP5 disposed adjacent to the fifth data line DL5, and the sixth pixel P6 is connected to a sixth data line DL6 through a sixth contact portion CP6 disposed adjacent to the sixth data line DL6. The seventh pixel P7 is connected to a seventh data line DL7 through a seventh contact portion CP7 disposed adjacent to the seventh data line DL7, and the eighth pixel P8 is connected to an eighth data line DL8 through an eighth contact portion CP8 disposed adjacent to the eighth data line DL8.

The ninth pixel P9 is connected to the first data line DL1 and the tenth pixel P10 is connected to the second data line DL2. The eleventh pixel P11 is connected to the fourth data line DL4 and the twelfth pixel P12 is connected to the third data line DL3. The thirteenth pixel P13 is connected to the sixth data line DL6 and the fourteenth pixel P14 is connected to the fifth data line DL5. The fifteenth pixel P15 is connected to the seventh data line DL7 and the sixteenth pixel P16 is connected to the eighth data line DL8.

In an exemplary embodiment of the display panel 100C, the contact portions of the pixels, which receive data voltages having same polarity, are substantially uniformly disposed on upper portions and lower portions of the pixels.

As shown in FIG. 7, the contact portion of the pixels that are disposed the first pixel row and receive data voltage having a positive polarity, e.g., the second contact portion CP2 and an ninth contact portion CP9, are disposed at upper portions of the pixels in the first pixel row adjacent to the first data line DL1, and the contact portions of the pixels that are disposed in the first pixel row and receive data voltages of negative polarity, e.g., the first contact portion CP1 and a tenth contact portion CP10 are disposed on the lower portion of the pixels adjacent to the second data line DL2. In addition, contact portions of pixels that are disposed in the second pixel row adjacent to the first pixel row and receive voltages of positive polarity are disposed on portions opposite to portions on which the contact portions of pixels that disposed in the first pixel row and receive voltages of positive polarity are disposed, and contact portions of pixels that are disposed in the second pixel row and receive voltages of negative polarity are disposed on portions opposite to portions on which the contact portions of pixels that are disposed in the first pixel row and receive voltages of negative polarity are disposed. As shown in FIG. 7, the contact portions of the pixels that are disposed in the second pixel row and receive data voltages of positive polarity, e.g., the fourth contact portions CP4 and an eleventh contact portion CP11, are disposed on lower portions of the pixels adjacent to the fourth data line DL4, and the contact portions of the pixels that are disposed in the second pixel row and receive data voltages of negative polarity, e.g., the third contact portion CP3 and a twelfth contact portion CP 12, are disposed on the upper portion of the pixels adjacent to the third data line DL3. In an exemplary embodiment, the contact portions of the pixels that are disposed in a same pixel row and receive data voltages of same polarity are disposed on the same portion of pixels.

The connection structure of the first pixel P1 to the sixteenth pixel P16 and the first data line DL1 to the eighth data line DL8, labeled “repeated structure” in FIG. 7, is repeated for subsequent gate lines, e.g., for third and fourth gate lines GL3 and GL4, as shown in FIG. 7, throughout the display panel 100C according to one or more embodiments, and thus any repetitive detailed description thereof will hereinafter be omitted.

The display panel 100C may receive data voltages in accordance with the two-inversion method, and may be driven using the 2×2 dot-inversion method as described above.

The display panel 100C may include the data fan-out parts which cross each other and receive the inversion signals from the data driving part in accordance with the two-inversion method.

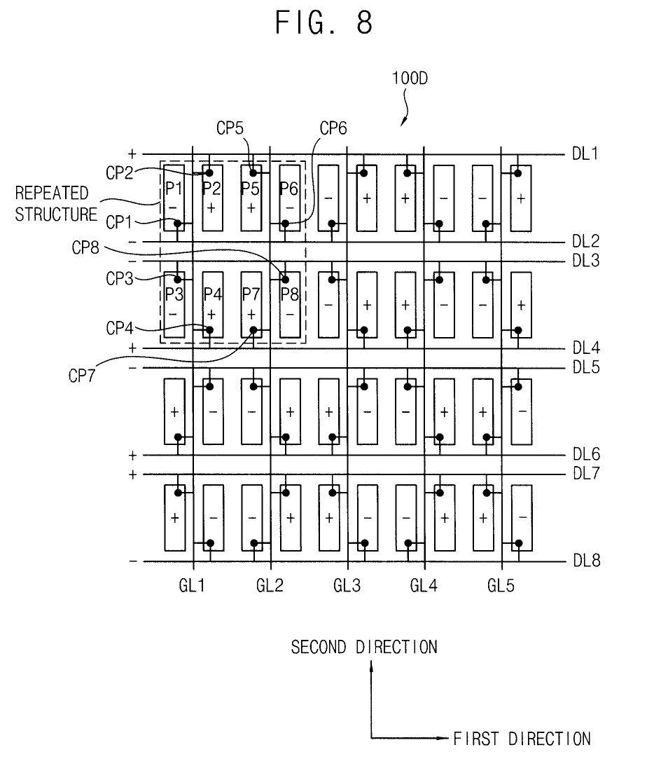

FIG. 8 is a plan view illustrating an exemplary embodiment of an arrangement structure of the data lines, the gate lines and the pixels of the display panel using an inversion driving method.

Referring to FIG. 2 and as shown in FIG. 8, the display panel 100D includes data lines, e.g., a first data line DL1, a second data line DL2, a third data line DL3, a fourth data line DL4, a fifth data line DL5, a sixth data line DL6, a seventh data line DL7 and an eighth data line DL8, gate lines e.g., a first gate line GL1, a second gate line GL2, a third gate line GL3, a fourth gate line GL4, and a fifth gate line GL5, and pixels connected to the data lines and the gate lines. The arrangement structure of the display panel 100D is substantially the same as the arrangement structure of the display panel shown in FIG. 2 except for the inversion driving method, the connection structure between the pixels and data lines and the arrangement structure of the contact portions.

The display panel 100D is driven in accordance with the 2×2 dot-inversion method using two-dot inversion in the longitudinal side direction and two-dot inversion in the transverse side direction. The polarities of data voltages applied to two dots may be different from each other. The display panel 100D receives data voltages in accordance with four-inversion method. An (8k−7)-th (‘k’ is a natural number), an (8k−6)-th, an (8k−5)-th, an (8k−4)-th, an (8k−3)-th, an (8k−2)-th, an (8k−1)-th and an 8k-th data lines, e.g., the first data line DL1, the second data line DL2, the third data line DL3, the fourth data line DL4, the fifth data line DL5, the sixth data line DL6, the seventh data line DL7 and the eighth data line DL8, receive data voltages have a polarity pattern of (+, −, −, +, −, +, +, −).

The connection structure between the pixels and the data lines and the arrangement structure of the contact portions of the display panel 100D of FIG. 8 will be described hereinafter.

As shown in FIG. 8, the display panel 100D includes a first pixel P1 and a third pixel P3 disposed in the first pixel row and connected to the first gate line GL1, a second pixel P2 and a fourth pixel P4 disposed in the second pixel row and connected to the first gate line GL1, a fifth pixel P5 and a seventh pixel P7 disposed in the third pixel row and connected to the second gate line GL2, and a sixth pixel P6 and an eighth pixel P8 disposed in the fourth pixel row and connected to the second gate line GL2.

The first pixel P1 is connected to the second data line DL2 through a first contact portion CP1 disposed adjacent to the second data line DL2, and the second pixel P2 is connected to the first data line DL1 through a second contact portion CP2 disposed adjacent to the first data line DL1. The third pixel P3 is connected to the third data line DL3 through a third contact portion CP3 disposed adjacent to the third data line DL3, and the fourth pixel P4 is connected to the fourth data line DL4 through a fourth contact portion CP4 disposed adjacent to the fourth data line DL4.

The fifth pixel P5 is connected to the first data line DL1, and the sixth pixel P6 is connected to the second data line DL2. The seventh pixel P7 is connected to the fourth data line DL4, and the eighth pixel P8 is connected to the third data line DL3.

The connection structure of the first pixel P1 to the eighth pixel P8 and the first data line DL1 to the fourth data line DL4 labeled as “repeated structure” in FIG. 8 is repeated for subsequent gate liens, e.g., for third and fourth gate lines GL3 and GL4, as shown in FIG. 8 throughout the display panel 100D according to one or more embodiments, and thus any repetitive detailed description thereof will hereinafter be omitted.

In the display panel 100D, the contact portions of the pixels that receive the voltages having the same polarity are substantially uniformly disposed on the upper portion and the lower portion of the pixels.

In an exemplary embodiment, the contact portions of the pixels that are disposed in the first pixel row and receive data voltages of positive polarity, e.g., the second contact portion CP2 and the fifth contact portion CP5, are disposed on the upper portion of the pixels adjacent to the first data line DL1, and the contact portions of the pixels that are disposed in the first pixel row and receive data voltages of negative polarity, e.g., the first contact portion CP1 and the sixth contact portion CP6, are disposed on the lower portions of the pixels adjacent to the second data line DL2. In addition, contact portions of pixels that are disposed in the second pixel row adjacent to the first pixel row and receive voltages of positive polarity are disposed on portions opposite to portions on which the contact portions of pixels that disposed in the first pixel row and receive voltages of positive polarity are disposed, and contact portions of pixels that are disposed in the second pixel row and receive voltages of negative polarity are disposed on portions opposite to portions on which the contact portions of pixels that are disposed in the first pixel row and receive voltages of negative polarity are disposed. The contact portions of the pixels that are disposed in the second pixel row and receive data voltages of positive polarity, e.g., the fourth contact portion CP4 and the seventh contact portion CP7, are disposed on the lower portion of the pixels adjacent to the fourth data line DL4, and the contact portions of the pixels that are disposed in the second pixel row and receive data voltages of negative polarity, e.g., the third contact portion CP3 and the eighth contact portion CP8, are disposed on the upper portion of the pixels adjacent to the third data line DL3. In an exemplary embodiment, the contact portions of the pixels that are disposed in a same pixel row and receive data voltages of same polarity are disposed on the same portion of the pixels.

In an exemplary embodiment, the display panel 100D may receive the data voltages using four-inversion method, and be driven using the 2×2-dot-inversion method by including the connection structure of the pixels and the data lines and the arrangement structure of the contact portions as shown in FIG. 8. The two dots may receive voltages of different polarities.

In an exemplary embodiment, the display panel 100D may include the data fan-out parts which cross and the data riving part which transmits the inversion signals and thereby receive the data voltage having the polarity according to the four-inversion method. The data voltages having polarities in accordance with the four-inversion method may be inverted in every frame.

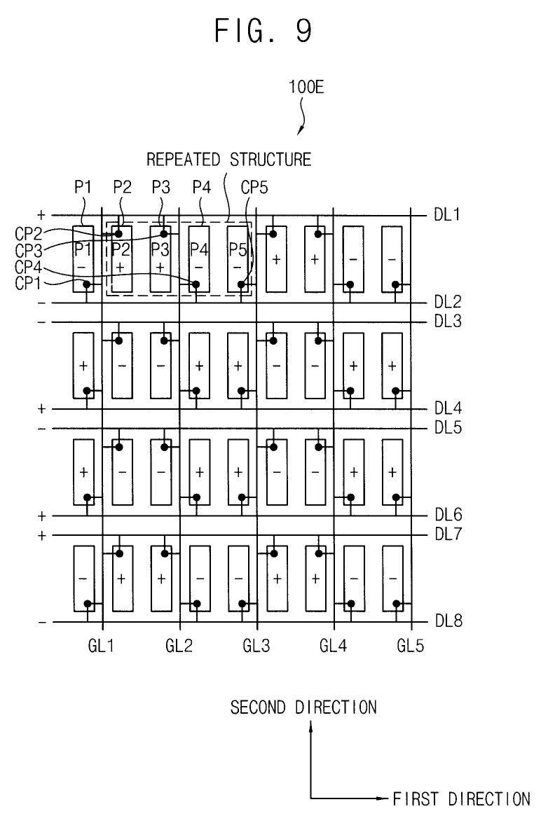

FIG. 9 is a plan view illustrating another exemplary embodiment of an arrangement structure of the data lines, the gate lines and the pixels of the display panel using an inversion driving method.

Referring to FIG. 2 and as shown in FIG. 9, the display panel 100E includes data lines the first data line DL1 to the eighth data line DL8, gate lines, e.g., the first gate line GL1 to the fifth gate line GL5, and pixels connected to the data lines and the gate lines. The arrangement structure of the data lines, the gate lines and the pixels in FIG. 9 is substantially the same as the arrangement structure in FIG. 2 except for the inversion driving method, the connection structure between the pixels and the data lines and the arrangement structure of the contact portions.

In an exemplary embodiment, the display panel 100E is driven using a 2×2-dot-inversion method including two-dot-inversion in a longitudinal side direction and two-dot-inversion driven in a transverse side direction. The two dots may receive voltages of different polarities. The display panel 100E receives data voltages in accordance with the eight-inversion method. An (8k−7)-th data line (‘k’ is a natural number), an (8k−6)-th data line, an (8k−5)-th data line, an (8k−4)-th data line, an (8k−3)-th data line, an (8k−2)-th data line, an (8k−1)-th data line and an 8k-th data line, for example, first to eighth data lines DL1, . . . , DL8 receive the data voltages having a polarity pattern of (+, −, −, +, −, +, +, −).

The connection structure between the pixel and data line and the arrangement structure of the contact portion of the display panel 100E will be described hereinafter.

As shown in FIG. 9, the display panel 100E includes a first pixel P1 in a first pixel column and a second pixel P2 in a second pixel column connected to a first gate line GL1, a third pixel P3 in a third pixel column and a fourth pixel P4 in a fourth pixel column connected to a second gate line GL2 adjacent to the first gate GL1, and a fifth pixel P5 in a fifth pixel column and a sixth pixel P6 in a sixth pixel column connected to a third gate line GL3 adjacent to the second gate line GL2. The first pixel P1 to the sixth pixel P6 are disposed in the first pixel row along the first direction.

The first, fourth and fifth pixels P1, P4 and P5 are connected to the second data lines DL2, and the second, third and sixth pixels P2, P3 and P6 are connected to the first data line DL1.

A first contact portion CP1 of the first pixel P1, a fourth contact portion CP4 of the fourth pixel P4 and a fifth contact portion CP5 of the fifth pixel P5 are connected to the second data line DL2, and a second contact portion CP2 of the second pixel P2, a third contact portion CP3 of the third pixel P3 and a sixth contact portion CP6 of the sixth pixel P6 are connected to the first data line DL1.

The connection structure of the second pixel P2 to the fifth pixel P5 and the first data line DL1 and the second data line DL2 and the arrangement structure of the second contact portion CP1 to the fifth contact portion disposed on the second pixel P2 to the fifth pixel P5, respectively, are repeated for subsequent gate lines, e.g., third, fourth and fifth gate lines GL3 to GL5, as shown in FIG. 9, throughout the display panel 100E according to one or more embodiments, and thus any repetitive detailed description thereof will hereinafter be omitted. The contact portions of the pixels which receive voltage of same polarity are substantially uniformly distributed in the display panel 100E.

In an exemplary embodiment, the contact portions of the pixels that are disposed in the first pixel row and receive voltages of positive polarity, e.g., the second contact portion CP2 and the fifth contact portion CP5, are disposed on the upper portion of the pixels adjacent to the first data line DL1, and the contact portions of the pixels that are disposed in the first pixel and receive voltages of negative polarity, e.g., the first contact portion CP1, the fourth contact portion CP4 and the fifth contact portion CP5, are disposed on the lower portion of the pixels adjacent to the second data lines DL2. Contact portions of pixels that are disposed in the second pixel row adjacent to the first pixel row and receive voltages of positive polarity are disposed on portions opposite to portions on which the contact portions of pixels that disposed in the first pixel row and receive voltages of positive polarity are disposed, and contact portions of pixels that are disposed in the second pixel row and receive voltages of negative polarity are disposed on portions opposite to portions on which the contact portions of pixels that are disposed in the first pixel row and receive voltages of negative polarity are disposed. For example, the contact portions of the pixel that are disposed in a same pixel row and receive data voltages of same polarity are disposed a same portion of pixels, e.g., one of the upper portion and the lower portion.

The display panel 100E may receive data voltages in accordance with the four-inversion method, and may be driven using the 2×2-dot-inversion method by including the connection structure between the pixels and the data lines and the arrangement structure of the contact portions as described above.

The display panel 100E may include the data fan-out parts which cross each other and receive the inversion signal from the data driving part in accordance with the eight-inversion method.

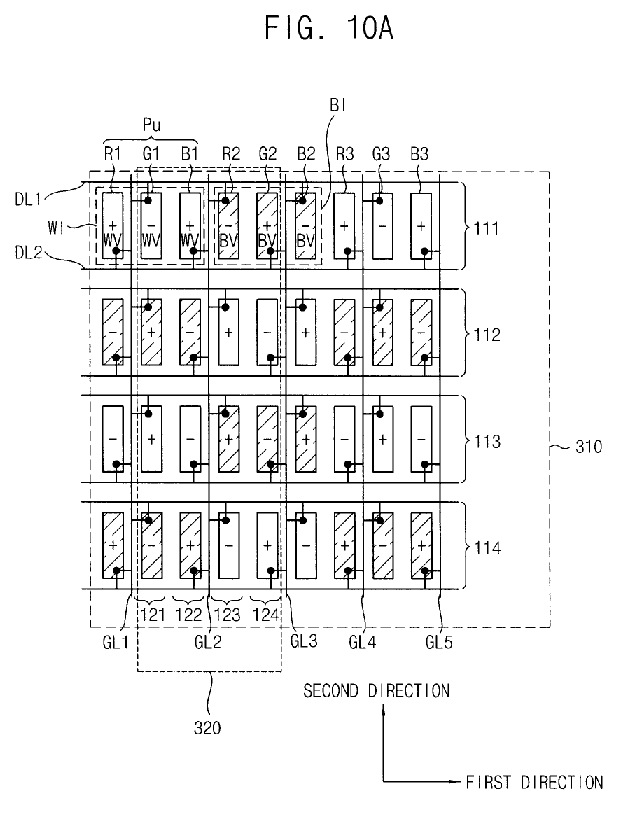

FIGS. 10A and 10B are plan views illustrating an exemplary embodiment of a stripe according to the present invention.

FIG. 10A shows an exemplary embodiment of a check pattern, of which white images and black images are alternately disposed, in the display apparatus driven using 1×2-dot-inversion method shown in FIG. 2. FIG. 10B shows the check pattern in the display apparatus driven using 2×2-dot-inversion methods shown in FIGS. 6, 7, 8 and 9. The display apparatus includes a unit pixel Pu including a red pixel, e.g., a first red pixel R1, a green pixel, e.g., a first green pixel G1 and a blue pixel, e.g., a first blue pixel B1. Pixels that display a white image WI may receive white gray level voltages WV and pixels that display a black image BI may receive black gray level voltages BV.

As shown in FIG. 10A, in the display apparatus driven using the 1×2-dot-inversion method, polarities of voltages applied to pixels included in a crosswise area 110 extended in the first direction and polarities of voltages applied to pixels included in a lengthwise area 120 extends in the second direction will be described hereinafter. The crosswise area 110 includes a first pixel row 111, a second pixel row 112, a third pixel row 113 and a fourth pixel row 114 adjacent to one another. In the first and second pixel rows 111 and 112, pixels that display a white image WI receive voltages having a polarity pattern of (+, −, +), and pixels displaying a black image BI receive voltages having a polarity pattern of (−, +, −). In the third and fourth pixel rows 113 and 114, the pixels that display a white image WI receive voltages having the polarity pattern of (−, +, −), and the pixels that display a black image BI receive voltages having the polarity pattern of (+, −, +). Accordingly, polarity patterns of the pixels that display the white image WI and the black image BI are substantially uniformly distributed in the crosswise area 110.

The lengthwise area 120 includes a first pixel column 121, a second pixel column 122, a third pixel column 123 and a fourth pixel column 124 adjacent to one another. In the first and second pixel columns 121 and 122, the pixels that display a white image WI alternately receive voltages having a polarity pattern of (−, +) and voltages having a polarity pattern of (+, −), and the pixels that display a black image BI alternately receive voltages having a polarity pattern of (+, −), and voltages having a polarity pattern of (−, +). In the third and fourth pixel columns 123 and 124, the pixels that display a white image WI alternately receive voltages having a polarity pattern of (+, −) and voltages having a polarity pattern of (−, +), and the pixels that display a black image BI alternately receive voltages having a polarity pattern of (−, +) and voltages having a polarity pattern of (+, −). In an exemplary embodiment, the polarity patterns of the pixels that display the white image WI and the black image BI are substantially uniformly distributed in the lengthwise area 120.

Accordingly, an exemplary embodiment of the display apparatus using a 1×2-dot inversion method effectively prevents a crosswise stripe effect and a lengthwise stripe effect.

The polarity patterns of the pixels of the display apparatus driven using a 2×2-dot inversion method included in a crosswise area 310 and a lengthwise area 320 will be described hereinafter.

In the first to fourth pixel rows 211 to 214 of the crosswise area 310, the pixels that display white images WI receive voltages having polarity patterns of (−, +, +), (+, −, −), (+, +, −) and (−, −, +) and the polarity patterns of the pixels that display white images are substantially uniformly distributed in the crosswise area 310, and the pixels that display black images BI receive voltages having the polarity patterns of (−, +, +), (+, −, −), (+, +, −) and (−, −, +) and the polarity patterns of pixels that display black images are substantially uniformly distributed in the crosswise area 310.

In the first to fourth pixel columns 221 to 224, the pixels that display white images WI receive voltage having a polarity pattern of (+ and +) and (−, −) and the polarity patterns of pixels that display white images are substantially uniformly distributed in the lengthwise area, and the pixels that display black images BI receive voltages having the polarity patterns of (+ and +) and (− and −) and the polarity patterns of pixels that display black images are substantially uniformly distributed in the lengthwise area 320.

Accordingly, an exemplary embodiment of a display apparatus using a 2×2-dot inversion method effectively prevents a crosswise stripe effect and a lengthwise stripe effect.

As a result, an exemplary embodiment of a display apparatus driven by 2-dot inversion in the transverse side direction effectively prevents defects such as stripes, for example.

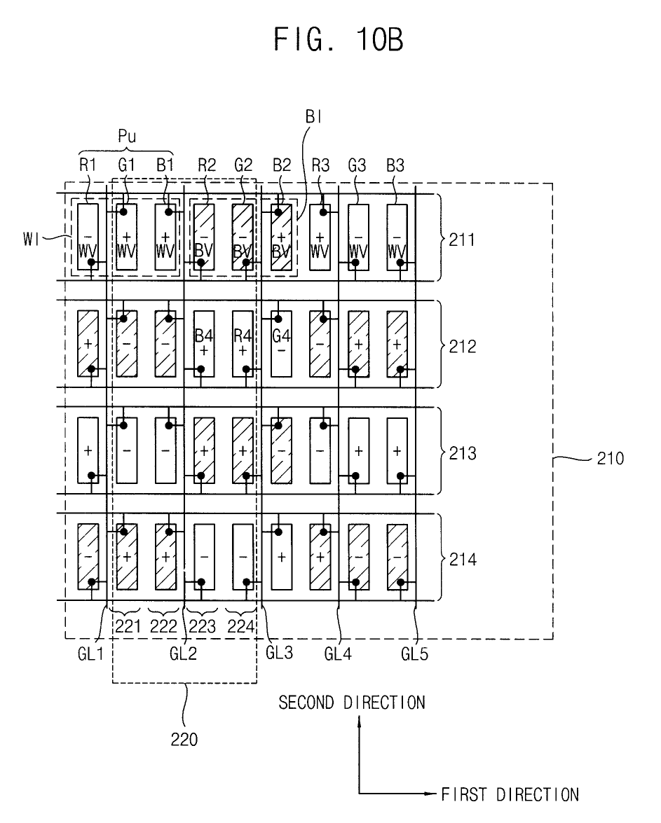

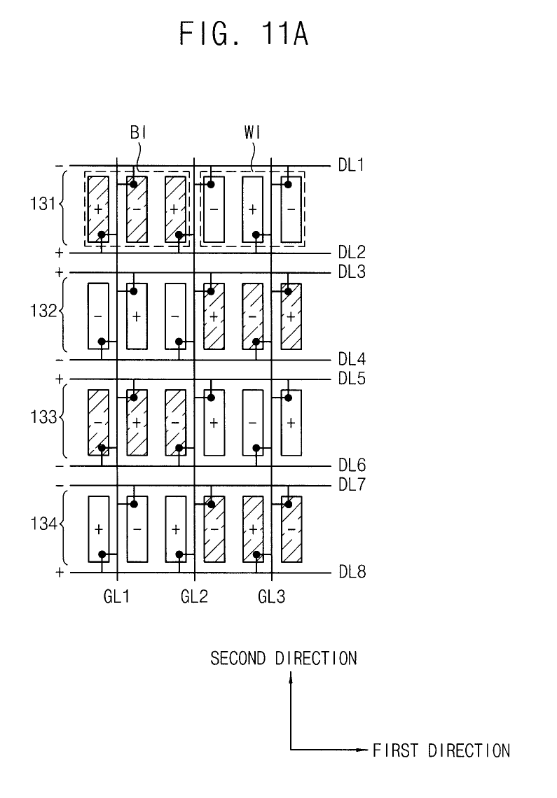

FIG. 11A is a plan view illustrating an exemplary embodiment of a display apparatus according to the present invention, and FIG. 11B is a signal timing diagram illustrating an exemplary embodiment of a coupling of a common voltage according to the present invention. Specifically, FIG. 11A shows a check pattern in an exemplary embodiment of a display apparatus driven by 2-dot inversion in the transverse side direction, and FIG. 11B shows signal timing of voltages applied to the pixels of FIG. 11A.

As shown in FIGS. 11A and 11B, the first to eighth data lines DL1 to DL8 respectively receive data voltages having a polarity pattern of (−, +, +, −, +, −, −, +) in accordance with an eight-inversion method. In an exemplary embodiment, the first, fourth, sixth and seventh data lines DL1, DL4, DL6 and DL7 receive the data voltages of negative polarity, e.g., a first data voltage −d1, a second data voltage −d3, a fifth data voltage −d5 and a seventh data voltage −d7 and the second, third, fifth and eighth data lines DL2, DL3, DL5 and DL8 receive data voltages of positive polarity, e.g., a second data voltage +d2, a fourth data voltage +d4, a sixth data voltage +d6 and an eighth data voltage +d8. The data voltages of negative polarity are voltages in a range of a common voltage Vcom and a ground voltage GND, and the data voltages of positive polarity are voltages in a range of a common voltage and a power voltage AVDD. The ground voltage GND and the power voltage AVDD are black gray level voltages.

In an exemplary embodiment, the first data line DL1 receives a black gray level voltage, e.g., the ground voltage GND, and the second data line DL2 receives a black gray level voltage, e.g., the power voltage AVDD, during the first horizontal interval H1 when the first gate line GL1 receives a gate signal. The first data line DL1 receives a white gray level voltage of negative polarity −WV and the second data line DL2 receives a black gray level voltage, e.g., the power voltage AVDD, during the second horizontal interval H2 when the second gate line GL2 receives a gate signal. The first data line DL1 receives the white gray level voltage of negative polarity −WV and the second data line DL2 receives a white gray level voltage of positive polarity +WV during the third horizontal interval H3 when the third gate line GL3 receives a gate signal.

As shown in FIG. 11B, a distortion of a first common voltage Vcom1 is generated when the first common voltage Vcom1 applied to the pixels of the first pixel row 131 connected to the first and second data lines DL1 and DL2 increases at a boundary between the first horizontal interval H1 and the second horizontal interval H2 and decreases at a boundary between the second horizontal interval H2 and the third horizontal interval H3 in accordance with changes of data voltages applied to the first and second data lines DL1 and DL2.

A distortion of a second common voltage Vcom2 is generated when the second common voltage Vcom2 applied to the pixels of the second pixel row 132 connected to the third and fourth data lines DL3 and DL4 increases at a boundary between the first horizontal interval H1 and the second horizontal interval H2 and decreases at a boundary between the second horizontal interval H2 and the third horizontal interval H3 in accordance with changes of data voltages applied to the third and fourth data lines DL3 and DL4.

A distortion of a third common voltage Vcom3 is generated when the third common voltage Vcom3 applied to the pixels of the third pixel row 133 connected to the fifth and sixth data lines DL5 and DL6 decreases at a boundary between the first horizontal interval H1 and the second horizontal interval H2 and increases at a boundary between the second horizontal interval H2 and the third horizontal interval H3 in accordance with changes of data voltages applied to the fifth and sixth data lines DL5 and DL6.

A distortion of a fourth common voltage Vcom4 is generated when the fourth common voltage Vcom4 applied to the pixels of the fourth pixel row 134 connected to the seventh and eighth data lines DL7 and DL8 decreases at a boundary between the first horizontal interval H1 and the second horizontal interval H2 and increases at a boundary between the second horizontal interval H2 and third horizontal interval H3, in accordance with changes of data voltages applied to the seventh and eighth data lines DL7 and DL8.

In an exemplary embodiment, the display apparatus driven by two-dot inversion in the transverse side direction offsets distortions of the first and second pixel rows 131 and 132 and distortions of the third and fourth pixel rows 133 and 134, and thereby effectively prevents an inferiority displayed as greenish due to a coupling of common voltages of the display apparatus.

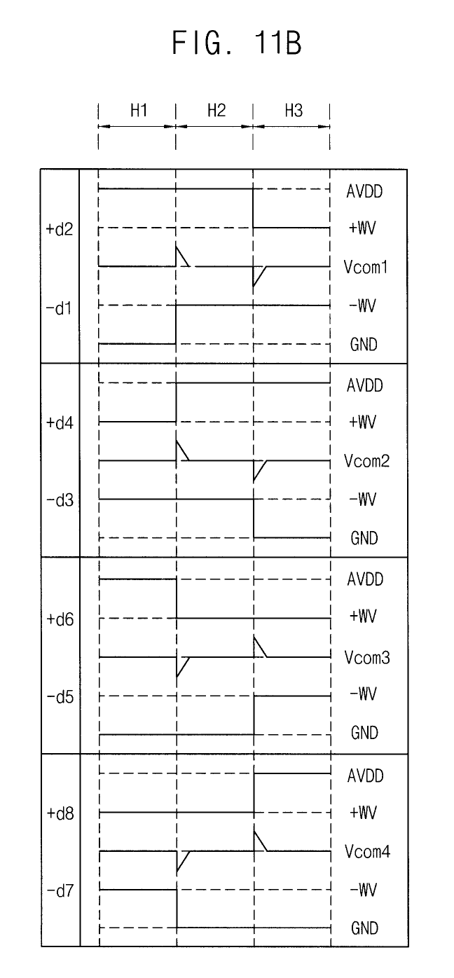

FIG. 12 is a plan view illustrating an exemplary embodiment of a gate metal pattern of gate lines and a source metal pattern of data lines of the display apparatus.

As shown in FIG. 12, the first gate line GL1 includes a gate metal pattern. The first gate line GL1 is disposed between the first pixel P1 and the second pixel P2. The first gate line GL1 includes a first gate electrode GE1 and a second gate electrode GE2. The first gate electrode GE1 protrudes toward the first pixel P1. The second gate electrode GE2 protrudes toward the second pixel P2.

The first data lines DL1 and the second data line DL2 extend in a direction crossing a direction that the first gate line GL1 are disposed along, and the first and second data lines DL1 and DL2 include source metal patterns. The first data line DL1 includes a first source electrode SE1 including a U-shape and protruding toward the first pixel, and the second data line DL2 includes a second source electrode SE2 including the U-shape and protruding toward the second pixel. In an exemplary embodiment, the first data line DL1 and the second data line DL2 include the source metal patterns. The first data line DL1 includes a first drain electrode DE1 spaced apart from the first source electrode SE1 and connected to the first pixel electrode PE1 through a contact hole. The second data line DL2 includes a second drain electrode DE2 disposed apart from the second source electrode SE2 and connected to the second pixel electrode PE2 through a contact hole.

In an exemplary embodiment, the first source electrode SE1 and the first gate electrode GE1 overlap each other, the second source electrode SE2 and the second gate electrode GE2 overlap each other, and an overlapping area of the first source electrode SE1 and the first gate electrode GE1 may be substantially a same as an overlapping area of second source electrode SE2 and the second gate electrode GE2. However, when the source metal pattern is not disposed at a predetermined portion of the gate metal pattern, the overlapping area of the first source electrode SE1 and the first gate electrode GE1 may be different from the overlapping area of the second source electrode SE2 and the second gate electrode GE2.

Accordingly, when the overlapping area of the first gate electrode GE1 and the first source electrode SE1 is greater than the overlapping area of the second gate electrode GE2 and the second source electrode SE2, a parasitic capacitance between a gate electrode and a source electrode of a first transistor TR1 is greater than a parasitic capacitance between a gate electrode and a source electrode of a second transistor TR2.

In an exemplary embodiment, when transistors of pixels that receive data voltages of same polarity are substantially uniformly disposed on the upper portions and the lower portions of the pixels, a flicker generated by misalignments between the gate metal patterns and the source metal patterns of FIG. 12 is effectively prevented.

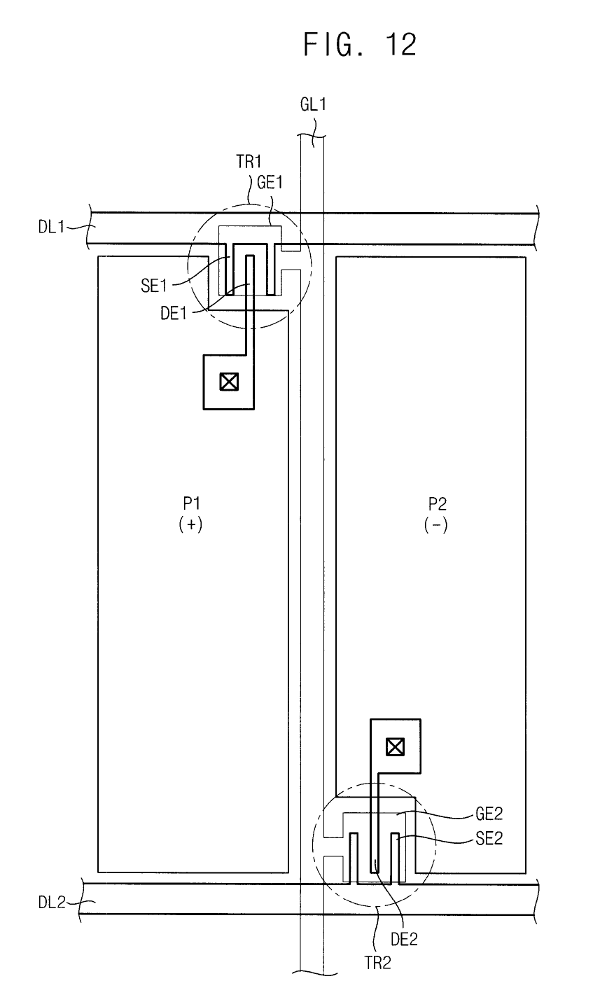

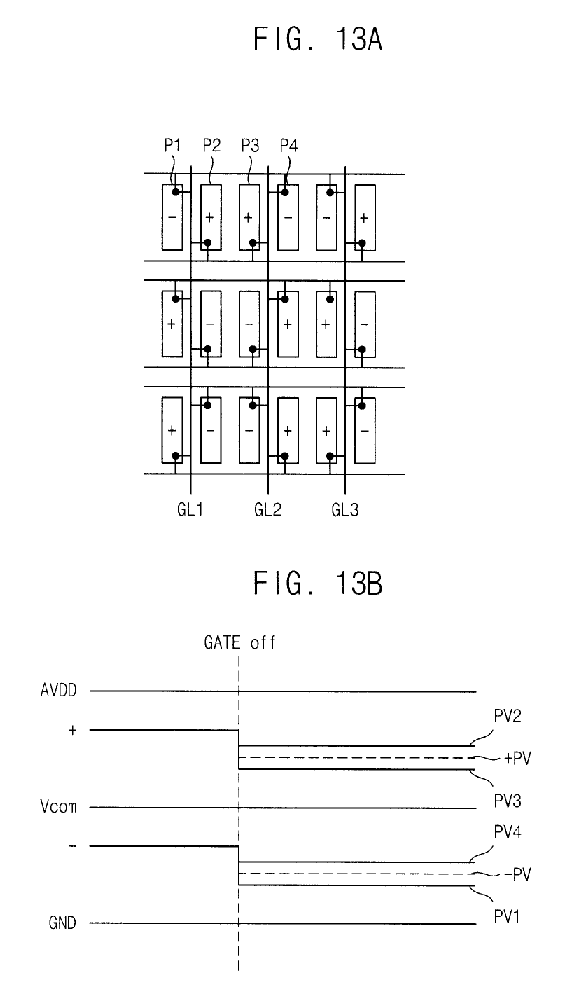

An exemplary embodiment of reducing display deterioration due to misalignment of gate lines will now be described. FIG. 13A is a plan view illustrating a display apparatus using two-dot inversion in the longitudinal side direction and including gate lines misaligned toward a left side of the display apparatus. FIG. 13B is a signal timing diagram showing an exemplary embodiment of waveforms of voltages applied to the pixels in FIG. 13A.

As shown in FIGS. 13A and 13B, the first gate line GL1 transmits a gate signal to the first and second pixels P1 and P2, and the second gate line GL2 transmits a gate signal to the third and fourth pixels P3 and P4.

The first gate line GL1 is disposed closer to the first pixel P1 than the second pixel P2, and the second gate line GL2 is disposed closer to the third pixel P3 than the fourth pixel P4 due to the misalignment of the first and second gate lines GL1 and GL2. Accordingly, a first pixel voltage PV1 lower than a normal pixel voltage of negative polarity −PV may be applied to the first pixel P1 due to the misalignment of the first gate line GL1, and a second pixel voltage PV2 higher than a normal pixel voltage of positive polarity +PV may be applied to the second pixel P2 due to the misalignment of the first gate line GL1.

Similarly, a third pixel voltage PV3 lower than the normal pixel voltage of positive voltage +PV may be applied to the third pixel P3 due to the misalignment of the second gate line GL2, and a fourth pixel voltage PV4 higher than the normal pixel voltage of negative polarity −PV may be applied to the fourth pixel P4 due to the misalignment of the second gate line GL2.

In an exemplary embodiment, when the first pixel P1 receive a data voltage of negative polarity, and the fourth pixel P4 receive a data voltage of negative polarity, the fourth pixel voltage PV4 may be higher than the second pixel voltage PV2, and an shortage of the first pixel voltage PV1 is thereby compensated by the fourth pixel voltage PV4. Similarly, a shortage of the third pixel voltage PV3 may be compensated by the second pixel voltage PV2.

Accordingly, in an exemplary embodiment of the display apparatus driven by two-dot inversion in the longitudinal side direction, the display inferiority due to the misalignment of the gate lines is substantially.

According to exemplary embodiments of the present invention as described herein, a display apparatus having a pixel structure driven by a dot inversion method substantially reduces the number of the data lines, display inferiority such as stripe inferiority, greenish display, flicker, etc. In addition, contact portions disposed on the pixels are substantially uniformly disposed, and thereby effectively prevent display inferiority due to the contact portions when the contact portions are substantially uniformly disposed in black matrix on array (“BOA”) panel of which black matrices are disposed at the contact portions.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A display apparatus comprising:
a display panel comprising:
pixels, each of the pixels comprising a transverse side and a longitudinal side;
data lines extending along a first direction; and
gate lines extending along a second direction substantially perpendicular to the first direction,
wherein the transverse side of the each of the pixels is disposed adjacent to at least one data line of the data lines,
the longitudinal side of the each of the pixels is disposed adjacent to at least one gate line of the gate lines, and
two adjacent pixels of the pixels, which are aligned adjacent to each other along the first direction, are connected to a same gate line of the gate lines disposed between the two adjacent pixels; and
a data driving part which transmits two-dot-inversed first direction data voltages to pixels disposed along the first direction and two-dot-inversed second direction data voltages to pixels disposed along the second direction.

2. The display apparatus of claim 1, wherein
the two adjacent pixels receive voltages of different polarities.

3. The display apparatus of claim 1, wherein
the data lines comprise:
an (8k−7)-th data line which receives an (8k−7)-th data voltage;
an (8k−6)-th data line which receives an (8k−6)-th data voltage;
an (8k−5)-th data line which receives an (8k−5)-th data voltage;
an (8k−4)-th data line which receives an (8k−4)-th data voltage;
an (8k−3)-th data line which receives an (8k−3)-th data voltage;
an (8k−2)-th data line which receives an (8k−2)-th data voltage;
an (8k−1)-th data line which receives an (8k−1)-th data voltage; and
an 8k-th data line which receives an 8k-th data voltage,
the (8k−7)-th data line, the (8k−6)-th data line, the (8k−5)-th data line, the (8k−4)-th data line, the (8k−3)-th data line, the (8k−2)-th data line, the (8k−1)-th data line and the 8k-th data line are disposed along the second direction,
a polarity of the (8k−7)-th data voltage, a polarity of the (8k−6)-th data voltage, a polarity of the (8k−5)-th data voltage and a polarity of the (8k−4)-th data voltage are opposite to a polarity of the (8k−3)-th data voltage, a polarity of the (8k−2)-th data voltage, a polarity of the (8k−1)-th data voltage and a polarity of the 8k-th data voltage, respectively, and
k is a natural number.

4. The display apparatus of claim 3, wherein the data driving part comprises output channels and outputs the (8k−7)-th data voltage, the (8k−6)-th data voltage, the (8k−5)-th data voltage, the (8k−4)-th data voltage, the (8k−3)-th data voltage, the (8k−2)-th data voltage, the (8k−1)-th data voltage and the 8k-th data voltage using one of a one-inversion method and a two-inversion method.

5. The display apparatus of claim 1, wherein
the display panel further comprises data fan-out parts which connect the output channels of the data driving part to the data lines, and
at least one pair of data fan-out parts of the data fan-out parts cross each other.

6. The display apparatus of claim 1, wherein
the display panel further comprises contact portions which connect the data lines to the pixels, and
contact portions disposed along the first direction and which receive data voltages having a same polarity among the two-dot-inversed first direction data voltages and the two-dot-inversed second direction data voltages are disposed adjacent to a same data line of the data lines.

7. The display apparatus of claim 1, wherein the display panel further comprises:
a first data line and a second data line adjacent to the first data line;
a first pixel disposed adjacent to a first gate line and connected to the second data line through a first contact portion disposed adjacent to the second data line;
a second pixel disposed adjacent to the first gate line and connected to the first data line through a second contact portion disposed adjacent to the first data line;
a third pixel disposed adjacent to the first gate line and connected to a third data line through a third contact portion disposed adjacent to the third data line, which is adjacent to the second data line;
a fourth pixel disposed adjacent to the first gate line and connected to a fourth data line through a fourth contact portion disposed adjacent to the fourth data line, which is adjacent to the third data line;
a fifth pixel disposed adjacent to a second gate line adjacent to the first gate line and connected to the first data line through a fifth contact portion disposed adjacent to the first data line;
a sixth pixel disposed adjacent to the second gate line and connected to the second data line through a sixth contact portion disposed adjacent to the second data line;
a seventh pixel disposed adjacent to the second gate line and connected to the fourth data line through a seventh contact portion disposed adjacent to the fourth data line; and
an eighth pixel disposed adjacent to the second gate line and connected to the third data line through an eighth contact portion disposed adjacent to the third data line.

8. The display apparatus of claim 1, wherein
the display panel further comprises:
a first pixel disposed adjacent to a first gate line and connected to a first data line through a first contact portion disposed adjacent to the first data line;
a second pixel disposed adjacent to a second gate line adjacent to the gate line and connected to the first data line through a second contact portion disposed adjacent to the first data line and adjacent to the first pixel along the first direction;
a third pixel disposed adjacent to the second gate line and connected to the second data line through a third contact portion disposed adjacent to a second data line, which is adjacent to the first data line; and
a fourth pixel disposed adjacent to the second gate line and connected to the second data line through a fourth contact portion disposed adjacent to the second data line.

9. The display apparatus of claim 1 wherein
the display panel further comprises contact portions which connect the data lines to the pixels, and
contact portions disposed long the first direction and which receive data voltages having a same polarity are alternately disposed adjacent to two data lines disposed above and below the contact portions disposed long the first direction, respectively.

10. The display apparatus of claim 1, wherein
the display panel further comprises:
a first data line and a second data line disposed adjacent to the first data line;
a first pixel disposed adjacent to a first gate line and connected to the second data line through a first contact portion disposed adjacent to the second data line;
a second pixel disposed adjacent to the first gate line and connected to the first data line through a second contact portion disposed adjacent to the first data line;
a third pixel disposed adjacent to a second gate line, which is adjacent to the first gate line, and connected to the second data line through a third contact portion disposed adjacent to the second data line; and
a fourth pixel disposed adjacent to the second gate line and connected to the first data line through a fourth contact portion disposed adjacent to the first data line.

11. The display apparatus of claim 10, wherein
the data driving part drives the display panel with data voltages by inverting polarities of the data voltages every horizontal interval period.

12. The display apparatus of claim 1, wherein
the data lines comprise:
a (4k−3)-th data line which receives a (4k−3)-th data voltage;
a (4k−2)-th data line which receives a (4k−2)-th data voltage;
a (4k−1)-th data line which receives a (4k−1)-th data voltage; and
a 4k-th data line which receives a 4k-th data voltage,
the (4k−3)-th data line, the (4k−2)-th data line, the (4k−1)-th data line and the 4k-th data line are disposed along the second direction, and
a polarity of the (4k−3)-th data voltage and a polarity of the (4k−2)-th data voltage are opposite to a polarity of the (4k−1)-th data voltage and a polarity of the 4k-th data voltage, respectively.

13. The display apparatus of claim 12, wherein the data driving part comprises output channels and outputs the (4k−3)-th data voltage, the (4k−2)-th data voltage, the (4k−1)-th data voltage and the 4k-th data voltage through the output channels using a one-inversion method.

14. The display apparatus of claim 13, wherein
the display panel further comprises data fan-out parts which connect the output channels of the data driving part to the (4k−3)-th data line, the (4k−2)-th data line, the (4k−1)-th data line and the 4k-th data line, and
at least one two data fan-out parts of the data fan-out parts cross each other.

15. The display apparatus of claim 12, wherein
the display panel further comprises contact portions which connect the (4k−3)-th data line, the (4k−2)-th data line, the (4k−1)-th data line and the 4k-th data line to corresponding pixels, and
contact portions disposed in a same pixel row and which receive data voltages of a same polarity are disposed adjacent to a same data line.

16. The display apparatus of claim 15, wherein the display panel further comprises:
a first pixel disposed adjacent to a first gate line and connected to a first data line through a first contact portion disposed adjacent to the first data line;
a second pixel disposed adjacent to the first gate line and connected to a second data line through a second contact portion disposed at the second data line, which is disposed adjacent to the first data line;
a third pixel disposed adjacent to the first gate line and connected to a third data line through a third contact portion disposed at the third data line, which is disposed adjacent to the second data line;
a fourth pixel disposed adjacent to the first gate line and connected to a fourth data line through a fourth contact portion disposed adjacent to the fourth data line, which is adjacent to the third data line;
a fifth pixel disposed adjacent to a second gate line, which is adjacent to the first gate line, and connected to the second data line through a fifth contact portion disposed adjacent to the second data line;
a sixth pixel disposed adjacent to the second gate line and connected to the first data line through a sixth contact portion disposed adjacent to the first data line;
a seventh pixel disposed adjacent to the second gate line and connected to the fourth data line through a seventh contact portion disposed adjacent to the fourth data line; and
an eighth pixel disposed adjacent to the second gate line and connected to the third data line through an eighth contact portion disposed adjacent to the third data line.

17. A display apparatus comprising:
a display panel comprising:
data lines comprising:
a first data line extending along a first direction;
a second data line extending along the first direction;
a third data line extending along the first direction and disposed adjacent to the second data line; and
a fourth data line extending along the first direction,
contact portions comprising:
a first contact portion disposed adjacent to the second data line;
a second contact portion disposed adjacent to the first data line;
a third contact portion disposed adjacent to the fourth data line; and
a fourth contact portion disposed adjacent to the third data line;
pixels comprising:
a first pixel disposed between the first data line and the second data line and connected to the second data line through the first contact portion;
a second pixel disposed between the first data line and the second data line and connected to the first data line through the second contact portion;
a third pixel disposed between the third data line and the fourth data line and connected to the fourth line through the third contact portion; and
a fourth pixel disposed between the third data line and the fourth data line and connected to the third data line through the fourth contact portion; and
gate lines comprising:
a first gate line extending along a second direction, substantially perpendicular to the first direction, and disposed between the first and second pixels and between the third and fourth pixels; and a second gate line extending along the second direction; and
a data driving part which transmits one-dot-inversed first direction data voltages to pixels disposed along the first direction and two-dot-inversed second direction data voltages to pixels disposed along the second direction.

18. The display apparatus of claim 17, wherein
the contact portions connects the data lines to the pixels, and
the contact portions disposed along the first direction and which receive data voltages having a same polarity among the one-dot inversed first direction data voltages and the two-dot-inversed second direction data voltages are disposed adjacent to a same data line of the data lines.

19. The display apparatus of claim 17, wherein
the data lines further comprise:
an (8k−7)-th data line which receives an (8k−7)-th data voltage;
an (8k−6)-th data line which receives an (8k−6)-th data voltage;
an (8k−5)-th data line which receives an (8k−5)-th data voltage;
an (8k−4)-th data line which receives an (8k−4)-th data voltage;
an (8k−3)-th data line which receives an (8k−3)-th data voltage;
an (8k−2)-th data line which receives an (8k−2)-th data voltage;
an (8k−1)-th data line which receives an (8k−1)-th data voltage; and
an 8k-th data line which receives an 8k-th data voltage,
the (8k−7)-th data line, the (8k−6)-th data line, the (8k−5)-th data line, the (8k−4)-th data line, the (8k−3)-th data line, the (8k−2)-th data line, the (8k−1)-th data line and the 8k-th data line are disposed along the second direction,
a polarity of the (8k−7)-th data voltage, a polarity of the (8k−6)-th data voltage, a polarity of the (8k−5)-th data voltage and a polarity of the (8k−4)-th data voltage are opposite to a polarity of the (8k−3)-th data voltage, a polarity of the (8k−2)-th data voltage, a polarity of the (8k−1)-th data voltage and a polarity of the 8k-th data voltage, respectively, and
k is a natural number.

20. The display apparatus of claim 19, wherein
the data driving part comprises output channels and outputs the (8k−7)-th data voltage, the (8k−6)-th data voltage, the (8k−5)-th data voltage, the (8k−4)-th data voltage, the (8k−3)-th data voltage, the (8k−2)-th data voltage, the (8k−1)-th data voltage and the 8k-th data voltage using at least one of a one-inversion method and a two-inversion method.
